(19) United States
(12) Patent Application Publication
(10) Pub. No.: US 2025/0086818 A1
(43) Pub. Date: Mar. 13, 2025

(54) IMAGE SIGNAL PROCESSOR AND DEPTH MAP GENERATION METHOD

(71) Applicant: SK hynix Inc., Icheon-si Gyeonggi-do (KR)

(72) Inventor: Ji Hee HAN, Icheon-si Gyeonggi-do (KR)

(73) Assignee: SK hynix Inc., Icheon-si Gyeonggi-do (KR)

(21) Appl. No.: 18/594,903

(22) Filed: Mar. 4, 2024

(30) Foreign Application Priority Data
Sep. 13, 2023 (KR) 10-2023-0121688

(51) Int. Cl. G06T 7/593; G06T 3/40; G06T 5/20; G06T 5/70; H04N 13/00; H04N 13/207; H04N 23/81

(52) U.S. Cl. CPC G06T 7/593; G06T 3/40; G06T 5/20; G06T 5/70; H04N 13/207; H04N 23/81; H04N 2013/0081

(57) ABSTRACT

The present technology relates to an image signal processor. According to the present technology, an image signal processor may include a depth map generator configured to generate, based on a target resolution of an output image, a downsized left image and a downsized right image based on an input image received from an external device, and generate a depth map image indicating depth values corresponding to pixels included in the output image based on the downsized left image and the downsized right image, and a noise remover configured to perform guide filtering on the depth map image using the input image as a guide image and generate the output image.

### CROSS-REFERENCE TO RELATED APPLICATION

The present application claims priority under 35 U.S.C. § 119 (a) to Korean patent application number 10-2023-0121688 filed on Sep. 13, 2023, in the Korean Intellectual Property Office, the entire disclosure of which is incorporated herein by reference.

### BACKGROUND

### 1. Technical Field

The present disclosure relates to an image signal processor, and more particularly, to an image signal processor and a method of generating a depth map.

### 2. Related Art

An image sensor may be generally categorized as a charge coupled device (CCD) image sensor or a complementary metal oxide semiconductor (CMOS) image sensor. Recently, a CMOS image sensor that is inexpensive to manufacture, consumes little power, and is easy to integrate with a peripheral circuit has been attracting attention.

An image sensor included in a smart phone, a tablet PC, a digital camera, or the like may convert light reflected from an external object into an electrical signal, to obtain image information for the external object. An image signal processor may perform an image processing operation based on image data received from the image sensor.

The image signal processor may calculate a distance between a subject and the image sensor using a left image and a right image. The image signal processor may generate a depth map image indicating depth values corresponding to each of pixels. When decreasing resolution of an image used when generating the depth map image, a speed of generating the depth map image may be increased, but accuracy of the generated depth map image may be decreased.

### SUMMARY

According to an embodiment of the present disclosure, an image signal processor may include a depth map generator configured to generate, based on a target resolution of an output image, a downsized left image and a downsized right image based on an input image received from an external device and generate a depth map image indicating depth values corresponding to pixels included in the output image based on the left image and the right image, and a noise remover configured to perform guide filtering on the depth map image using the input image as a guide image and generate the output image.

According to an embodiment of the present disclosure, a method of operating an image signal processor may include receiving a left image and a right image from an external device, determining at least one similarity value between a left pixel sampled from the left image according to a ratio determined based on target resolution of an output image and right pixels sampled from the right image according to the ratio, calculating a disparity value between the left pixel and a comparison pixel determined based on the at least one similarity value for the right pixels, generating, based on the disparity value, a depth map image indicating depth values corresponding to pixels included in the output image, and performing a guide filtering operation on the depth map image using the left image as a guide image.

According to an embodiment of the present disclosure, an image system may include an image sensor including a plurality of pixels and configured to generate an image including pixel values corresponding to each of the plurality of pixels, and an image signal processor configured to perform, based on target resolution of an output image, a sampling operation on an image received from the image sensor and perform an image processing operation based on an intermediate image on which the sampling operation is performed. The image processing operation may include a noise removal operation, and the image signal processor may include a noise remover that performs a noise removal operation by guide filtering using the image received from the image sensor as a guide image.

According to an embodiment of the present disclosure, an image system may include an image sensor including a plurality of pixels and configured to generate an input image; and a processor and memory configured to: generate a downsized left image and a downsized right image based on the input image, generate a depth map image indicating depth values based on the downsized left image and the downsized right image, remove noise by guide filtering the depth map image using the input image as a guide image, and generate an output image based on the guide-filtered depth map image.

### BRIEF DESCRIPTION OF THE DRAWINGS

FIG. 1 is a diagram illustrating an image system according to an embodiment of the present disclosure.

FIG. 2 is a diagram illustrating a depth map image generation process according to an embodiment of the present disclosure.

FIG. 3 is a diagram illustrating a depth map image generation process according to another embodiment of the present disclosure.

FIG. 4 is a diagram illustrating similarity and disparity used in depth map image generation according to an embodiment of the present disclosure.

FIG. 5 is a diagram illustrating a guide filtering operation according to an embodiment of the present disclosure.

FIG. 6 is a diagram illustrating a filtering operation that varies according to a guide image.

FIG. 7 is a diagram illustrating a filtering area utilizing a weight that varies based on a distance from a target pixel according to an embodiment of the present disclosure.

FIG. 8 is a flowchart illustrating a method of generating a depth map image according to an embodiment of the present disclosure.

FIG. 9 is a block diagram illustrating an electronic device including an image signal processor according to an embodiment of the present disclosure.

### DETAILED DESCRIPTION

Specific structural or functional descriptions of embodiments according to the concept which are disclosed in the present specification or application are illustrated only to describe the embodiments according to the concept of the present disclosure. The embodiments according to the concept of the present disclosure may be carried out in various forms and the descriptions are not limited to the embodiments described in the present specification or application.

According to the present disclosure, an image signal processor and a depth map generation method capable of improving depth map image generation speed and accuracy may be provided. The accuracy of the depth map image may be improved by performing a noise removal operation on the generated depth map image. An embodiment of the present disclosure provides an image signal processor and a depth map generation method capable of improving a depth map generation speed by sampling an original image and generating a depth map image based on an image of which resolution is decreased and capable of improving accuracy of the generated depth map image by performing a guide filtering operation using the original image as a guide image on the depth map image.

Various embodiments of the present disclosure are described in detail with reference to the accompanying drawings.

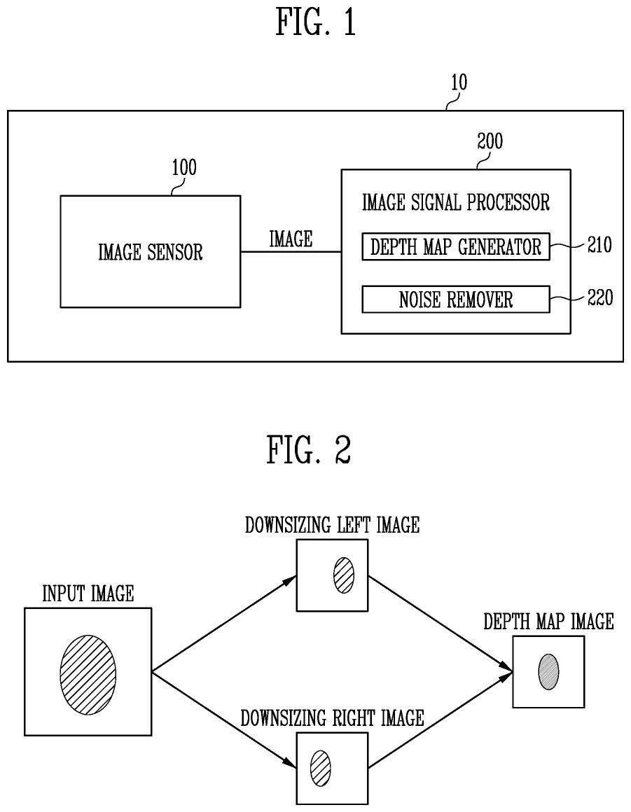

FIG. 1 is a diagram illustrating an image system according to an embodiment of the present disclosure.

Referring to FIG. 1, the image system 10 includes an image sensor 100 and an image signal processor 200. The image sensor 100 includes a pixel array including a plurality of pixels. The image sensor 100 generates an image, also referred to as image data, including pixel values corresponding to the plurality of pixels. The image signal processor 200 performs an image processing operation based on the image received from the image sensor 100. The image received from the image sensor 100 may be referred to as an original image. The image signal processor 200 includes a depth map generator 210 and a noise remover 220 as shown in the example of FIG. 1.

Some of the plurality of pixels included in the image sensor 100 may be phase difference pixels. Each normal pixel may correspond to one micro lens, and the phase difference pixels may be pixels that share the same micro lens, i.e., one micro lens may direct light onto two or more phase difference pixels. The image signal processor 200 may generate a left image and a right image with disparity based on the image received from the image sensor 100. Disparity includes, for example, a difference between the left image and the right image for the same object. The disparity of the left image and the right image may vary according to a distance between the image sensor 100 and an object included in the image. As the distance between the object and the image sensor 100 increases, a disparity value may increase.

The depth map generator 210 may sample the image received by the image signal processor 200 and generate a downsized left image and a downsized right image. A sampling rate of the depth map generator 210 may be determined based on resolution of an output image.

The depth map generator 210 may calculate at least one similarity value and at least one disparity value from the left image and the right image. The similarity values and the disparity values may be calculated for each of the pixels included in the image. The depth map generator 210 may generate, based on the calculated disparity values, a depth map image indicating depth values corresponding to pixels included in the output image. The depth value may indicate the distance between each pixel of the image sensor 100 and the object included in the image.

The noise remover 220 performs a noise removal operation on the depth map image in this example. The noise remover 220 may perform a guide filtering operation as the noise removal operation. The guide filtering operation may perform a filtering operation using a guide image.

In another embodiment of the present disclosure, the image system 10 may include a plurality of image sensors. For example, the image system 10 may include an image sensor that generates the left image and another image sensor that generates the right image. The image signal processor 200 receives the left image and the right image from the image sensors. The depth map generator 210 generates the depth map image based on the received left image and received right image.

In still another embodiment of the present disclosure, the image signal processor 200 may perform a sampling operation on the image received from the image sensor 100 based on target, or selected, resolution of the output image. The image signal processor 200 may perform an image processing operation based on an intermediate image on which the sampling operation is performed. When performing the noise removal operation included in the image processing operation, the image signal processor 200 may perform the guide filtering operation using the image received from the image sensor 100 as the guide image. The image signal processor 200 may perform the sampling operation to reduce the amount of data on which the image processing operation is performed, thereby improving speed of the image processing operation. The image signal processor 200 may improve accuracy of an image processing operation result by using the received image, rather than a sampled image, as the guide image.

FIG. 2 is a diagram illustrating a depth map image generation process according to an embodiment of the present disclosure.

Referring to FIG. 2, the depth map generator 210 generates a downsized left image and a downsized right image based on the input image. The depth map generator 210 may generate the depth map image based on the downsized left image and right image. Because an amount of data utilized to generate the depth map image is reduced, depth map generation speed for a method of generating the depth map image after downsizing the input image may be faster than the speed for a method of generating the depth map based on the input image followed by downsizing the depth map. In the example of FIG. 2, the image signal processor 200 may receive from the image sensor 100 an input image including the phase-difference pixel data.

The depth map generator 210 may generate the downsized left image and the downsized right image according to the target resolution of the output image based at least in part on the input image received from an external device. The downsized left image and the downsized right image may be referred to as intermediate images. Resolution of the depth map image may have the same resolution as the output image. Resolution may refer to a degree of detail with which an image is provided or expressed. The resolution may be expressed as the quantity of pixels included in a predetermined area.

In the example of FIG. 2, an ellipse-shaped object is positioned at a center of an input image. The depth map generator 210 may generate downsized images obtained by sampling the input image based on the resolution of the output image. A size of the downsized left image may be reduced compared to a size of the input image, and the ellipse-shaped object may be positioned closer to a right side from the center of the left image. In the downsized right image, the ellipse-shaped object may be positioned on a left side from the center of the right image.

The depth map generator 210 may generate the depth map image based on the downsized left image and the downsized right image. The depth map generator 210 may calculate disparity values for the left image and the right image based on the similarity of the left image and the right image. The depth map generator 210 may calculate the depth values based on the disparity value. Similarity and disparity are described in more detail with respect to FIG. 4.

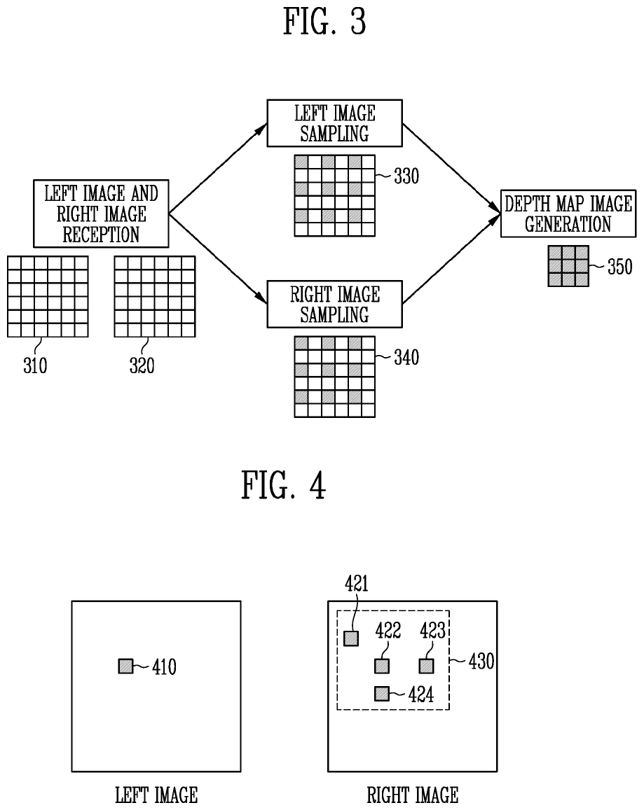

FIG. 3 is a diagram illustrating a depth map image generation process according to another embodiment of the present disclosure.

Referring to FIG. 3, the image signal processor 200 receives a left image 310 and a right image 320 from respective image sensors. The image sensors may not include phase difference pixels. The depth map generator 210 may not generate a downsized left image and a downsized right image and may generate a depth map image 350 based on sampling results 330 and 340 of the left image 310 and the right image 320, respectively.

The depth map generator 210 may compare the sampling results 330 and 340 of the left image 310 and the right image 320 in terms of pixel units or pixels. In the example of FIG. 3, one pixel among 2×2 pixels is sampled. The depth map generator 210 may determine similarity between a left pixel sampled from the left image according to a ratio determined based on the target resolution of the output image and right pixels sampled from the right image according to the ratio determined based on the target resolution. The ratio may be a ratio between a resolution of the left image 310 or the right image 320 and the target resolution. The depth map generator 210 may calculate the disparity value between the left pixel and the right pixel based on the determined similarity. The depth map generator 210 generates the depth map image indicating the depth values corresponding to the respective pixels included in the output image based on the disparity values.

In an embodiment of the present disclosure, the left image 310 and the right image 320 are received as shown in the embodiment of FIG. 3, however, the image signal processor 200 may receive a plurality of three or more images and may generate the depth map image based on the plurality of received images.

FIG. 4 is a diagram illustrating similarity and disparity used in depth map image generation according to an embodiment of the present disclosure.

Referring to FIG. 4, the depth map generator 210 may calculate the similarity and the disparity between the pixels by comparing the left image and the right image. The similarity and the disparity may be calculated in pixel units. In FIG. 4, a left pixel 410 and right pixels 421, 422, 423, and 424 are shown. The right pixels 421, 422, 423, and 424 may be pixels included in a search area 430. The search area 430 may be set around a second right pixel 422 corresponding to a position of the left pixel 410.

The depth map generator 210 calculates similarity between the left pixel 410 and each of the right pixels 421, 422, 423, and 424. The similarity may be determined based on a pixel value difference or a correlation. Because a method of determining the similarity between the pixels based on the pixel value difference or the correlation is publicly known technology, a description thereof is not provided in the present disclosure.

The depth map generator 210 may calculate a first similarity between the left pixel 410 and a first right pixel 421, calculate a second similarity between the left pixel 410 and the second right pixel 422, calculate a third similarity between the left pixel 410 and a third right pixel 423, and calculate a fourth similarity between the left pixel 410 and a fourth right pixel 424. The depth map generator 210 determines as a comparison pixel a right pixel with the highest similarity among the first similarity, the second similarity, the third similarity, and the fourth similarity. For example, when the third similarity has the highest value, the depth map generator 210 determines that the third right pixel 423 is the comparison pixel for the left pixel 410. The depth map generator 210 may calculate a disparity value between the left pixel 410 and the third right pixel 423. The disparity value may include a distance between the left pixel 410 and the third right pixel 423. As the disparity value increases, a depth value indicating a distance between the image sensor 100 and an object indicated by the left pixel 410 and the third right pixel 423 increases.

In the above example of FIG. 4, the similarity of some pixels included in the search area 430 and the left pixel 410 is calculated in this embodiment, and the depth map generator 210 may determine the comparison pixel by calculating a similarity for all pixels included in the search area 430 and the left pixel 410. A disparity value may be calculated using the same method for all left pixels included in the left image.

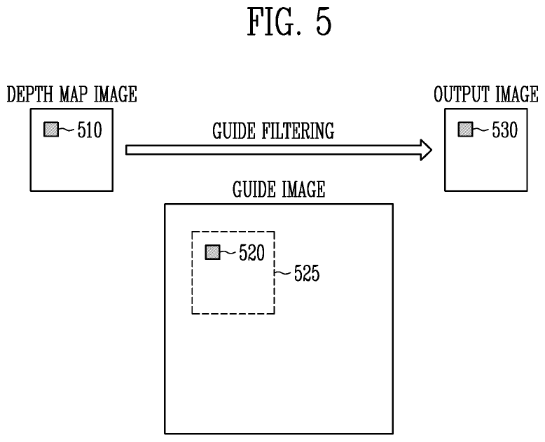

FIG. 5 is a diagram illustrating a guide filtering operation according to an embodiment of the present disclosure.

Referring to FIG. 5, the noise remover 220 performs the guide filtering operation on the depth map image using the input image as the guide image. In the example of FIG. 5, a first target pixel 510 included in the depth map image, a second target pixel 520 corresponding to a position of the first target pixel 510 in the guide image, and a third target pixel 530 corresponding to the position of the first target pixel 510 in the output image are shown.

For convenience of description, a process by which the guide filtering operation is performed on the first target pixel 510 is described as an example. Using the same method in which the guide filtering operation is performed on the first target pixel 510, the guide filtering operation may also be performed on other pixels included in the depth map image.

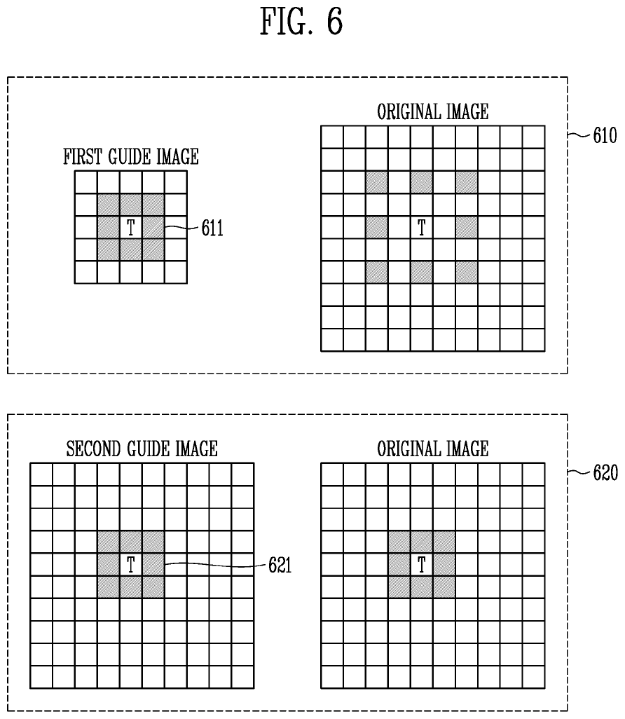

In FIG. 5, because the depth map image is generated by sampling the input image, a size of the input image is larger than the depth map image and resolution of the input image is higher than the resolution of the depth map image. To improve accuracy of the depth map image, the noise remover 220 may use the input image as the guide image because the input image has a higher resolution than the resolution of the depth map image. The accuracy of the depth map image is improved by using the input image as the guide image such as described in the text related to FIG. 6.

The noise remover 220 may determine the second target pixel 520 corresponding to the position of the first target pixel 510 in the guide image. The noise remover 220 may set a filtering area 525 corresponding to the second target pixel 520 to the guide image. The noise remover 220 may determine a pixel value of the third target pixel 530 based on pixel values included in the filtering area 525.

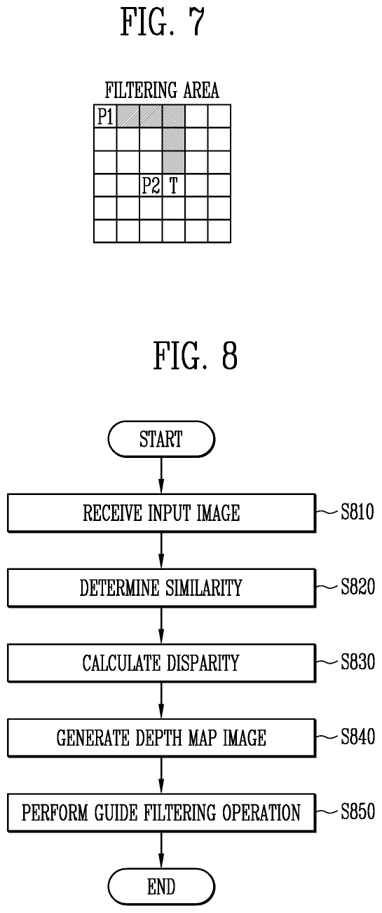

The noise remover 220 may set the filtering area 525 as an area centered on the second target pixel 520. A size of the filtering area 525 may be predetermined or set by a user. In another embodiment of the present disclosure, the noise remover 220 may set the entire input image as the filtering area 525 regardless of the position of the first target pixel 510. An example where the entire input image is the filtering area 525 is described with respect to FIG. 7.

The noise remover 220 may calculate an average pixel value of pixels included in the filtering area 525. The noise remover 220 may determine the pixel value of the third target pixel 530 as the calculated average pixel value. The noise remover 220 may assign a weight to the average pixel value based on a distance between the pixels included in the filtering area 525 and the second target pixel 520. In an embodiment of the present disclosure, the weight may be decreased as a distance from the second target pixel 520 increases.

FIG. 6 is a diagram illustrating a filtering operation that varies according to the guide image.

Referring to FIG. 6, in a first example 610, a downsized image, according to the target resolution of the output image, is used as the guide image. In a second example 620, an input image that is not downsized is used as the guide image. For convenience of description, a pixel corresponding to a position of the target pixel of the depth map image is indicated as T in each of a first guide image, a second guide image, and an original image, and the pixels included in the filtering area are illustrated as shaded. A size of the filtering area is the same as 3×3 in the first example 610 and the second example 620.

In the first example 610, pixels included in the first filtering area 611 are pixels adjacent to the target pixel in the first guide image but are pixels distant from the target pixel by a predetermined distance or more in the original image. Because the first guide image is a downsized image, pixels for which the filtering operation are used may not be pixels that are closest to the target pixel. In the first example 610, when the guide filtering operation is performed as the noise removal operation, the accuracy of the depth map image that is the output image may be deteriorated.

In the second example 620, pixels included in the second filtering area 621 are pixels adjacent to the target pixel in the second guide image and are pixels adjacent to the target pixel in the original image. Because the second guide image is the same size as the image received by the image signal processor 200, positions of pixels included in the second filtering area 621 may be maintained in the same positions in the second guide image and the original image.

The accuracy of the depth map image on which the guide filtering operation is performed as the noise removal operation may be higher in the second example 620 than the accuracy of the depth map image in the first example 610. The noise remover 220 may improve the accuracy of the depth map image, which was decreased due to the sampling operation performed to improve the depth map image generation speed, by performing the guide filtering operation on the depth map image according to the second example 620.

For the guide filtering operation corresponding to the second example 620, the image signal processor 200 may further include a buffer for storing the input image. After the sampling operation on the input image is performed, the image signal processor 200 may store the input image in the buffer. The input image stored in the buffer may be used as the guide image during the noise removal operation. In a non-limiting example, a received left image or a received right image may be utilized as the guide image.

FIG. 7 is a diagram illustrating a filtering area utilizing a weight that varies based on a distance from a target pixel according to an embodiment of the present disclosure.

Referring to FIG. 7, the filtering area set in the guide image is shown. In an embodiment of the present disclosure, the filtering area may be set to the entire guide image. The filtering area may include a target pixel T for which a pixel value is determined. For convenience of description, a first pixel P1 that is not adjacent to the target pixel T and a second pixel P2 adjacent to the target pixel T are shown in FIG. 7.

The noise remover 220 determines the pixel value of the target pixel T based on the pixel values included in the filtering area. The noise remover 220 may determine the average pixel value or the weight average value of the pixel values included in the filtering area as the pixel value of the target pixel T. In the example of FIG. 7, the weight average value of the pixel values included in the filtering area is used.

The noise remover 220 may calculate the weight based on a distance between the target pixel T and each of the pixels included in the filtering area. The noise remover 220 may determine a lower weight as the distance from the target pixel T increases. In FIG. 7, because a first distance between the first pixel P1 and the target pixel T is greater than a second distance between the second pixel P2 and the target pixel T, a first weight applied to the pixel value of the first pixel P1 may be less than a second weight applied to the pixel value of the second pixel P2.

The noise remover 220 may apply a higher weight to pixel values of pixels closer to the target pixel T. For example, a pixel value for a pixel that is far from the target pixel T may have less influence on the pixel value for the target pixel T than a pixel value for a pixel adjacent to the target pixel T. The noise remover 220 may determine the average value of the weighted pixel value as the pixel value for the target pixel T.

FIG. 8 is a flowchart illustrating a method of generating a depth map image according to an embodiment of the present disclosure.

Referring to FIG. 8, the image signal processor generates the depth map image by sampling the received image and improves the accuracy of the generated depth map image based on the input image. Because the depth map image is generated by sampling the image, the speed of generating the depth map image is improved.

The image signal processor receives S810 the input image. The input image may include the left image and the right image used in the depth map image generation. The left image and the right image may be generated from one image or may be received from the plurality of image sensors.

The depth map generator determines S820 the similarity between the left pixel sampled from the left image according to the ratio determined based on the target resolution of the output image and the right pixels sampled from the right image according to the ratio. In an embodiment of the present disclosure, the similarity may be determined based on the pixel value difference between the left pixel and the right pixel or a normalized correlation between the left pixel and the right pixel.

The depth map generator calculates S830 the disparity value between the left pixel and the comparison pixel determined based on the similarity among the right pixels. The depth map generator determines as the comparison pixel the pixel with the highest similarity to the left pixel among the right pixels. The depth map generator determines the distance between the left pixel and the comparison pixel as the disparity value.

Although the similarity and the disparity are calculated S820, S830 using the left pixel and the right pixels in the example of FIG. 8, the similarity and the disparity may be calculated using the left pixels and a right pixel in another embodiment. The method of calculating S820, S830 the similarity and the disparity may correspond to the description of FIG. 4.

The depth map generator generates S840 the depth map image indicating the depth values corresponding to the pixels included in the output image based on the disparity values. Examples of a method of generating the depth map image are illustrated in FIG. 2 and FIG. 3 and described in the associated text.

The noise remover performs S850 the guide filtering operation using the input image as the guide image to the depth map image. The noise remover identifies one of the left image and the right image included in the input image as the guide image. The noise remover may set the filtering area for the guide image to an area correspond to the target pixel included in the depth map image. The noise remover may determine the pixel value of the target pixel based on the pixel values included in the filtering area. Examples of a method by which the noise remover performs the guide filtering operation to generate the output image are illustrated in FIG. 5, FIG. 6, and FIG. 7 and described in the associated text.

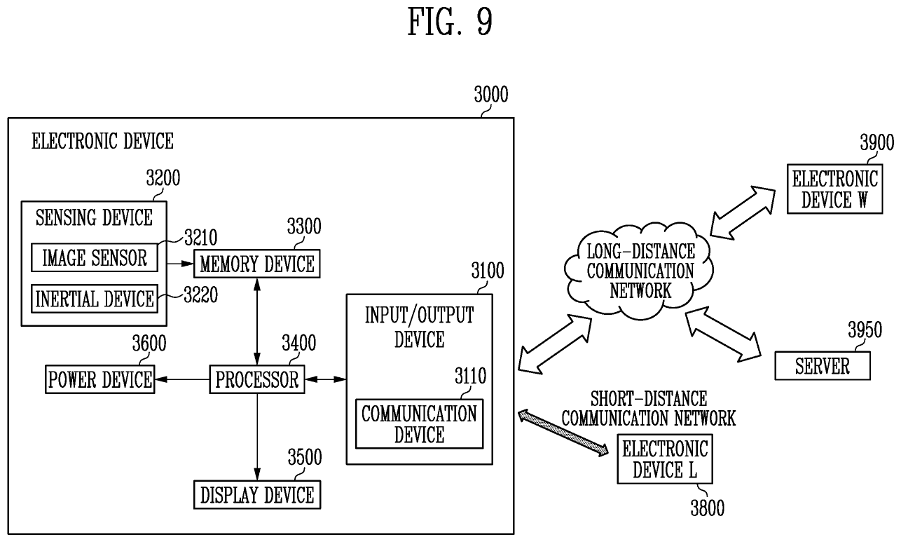

FIG. 9 is a block diagram illustrating an electronic device including an image signal processor according to an embodiment of the present disclosure.

Referring to FIG. 9, the electronic device 3000 includes an input/output device 3100, a sensing device 3200, a memory device 3300, a processor 3400, a display device 3500, and a power device 3600. For example, the electronic device 3000 may be a smart phone, a wearable device, a home appliance, a medical device, a measurement device, and so forth.

The input/output device 3100 outputs data or a command generated by the electronic device 3000 to other electronic devices or receives data or a command generated by other electronic devices. The input/output device 3100 may include a communication device 3110 capable of transmitting and receiving data to and from a device outside the electronic device 3000.

The communication device 3110 may connect the electronic device 3000 with other electronic devices using wired or wireless communication. The communication device 3110 may communicate with another electronic device W 3900 or a server 3950 through a long-distance communication network or may communicate with a peripheral electronic device L 3800 through a short-distance communication network. The electronic device 3000 may be connected to the electronic device L 3800 through a short-distance communication network or may be connected to the electronic device W 3900 or the server 3950 through a long-distance communication network. A system including electronic devices connected through a communication network may be utilized.

For example, the server 3950 may store data received from electronic devices or may comprehensively manage the electronic devices based on received data. In addition, the electronic device 3000 may generate data related to the electronic device 3000 based on data stored in the server 3950 or generate a command for controlling the electronic device L 3800 and the electronic device W 3900.

The sensing device 3200 may include an image sensor 3210 and an inertial sensor 3220. The sensing device 3200 may sense a change of the viewpoint of the electronic device 3000 through the image sensor 3210, for example, what the electronic devices views based in image sensor 3210 data and sense a change in position or orientation of the of the electronic device 3000 through the inertial sensor 3220. Sensing data generated by the sensing device 3200 may be transferred to and stored in the memory device 3300. In an embodiment of the present disclosure, the sensing device 3200 may include a plurality of image sensors or may include an image sensor including phase difference pixels.

The memory device 3300 may store data used by the electronic device 3000. The memory device 3300 may store software or programs or may store sensing data and commands generated by the electronic device 3000. In addition, the memory device 3300 may store user information, data, and commands received through the input/output device 3100. The memory device 3300 may include a volatile memory in which data is maintained only when power is supplied, and a non-volatile memory in which data is maintained regardless of power supply. In an embodiment of the present disclosure, a data receiver may store image data in the memory device.

The processor 3400 may control overall operation of the electronic device 3000. The processor 3400 may execute software, process data, or perform an operation. The software may comprise instructions that, when executed by the processor, perform any of the processes or operations described herein. The software may include firmware. The processor 3400 may be a microprocessor, a central processing unit (CPU), an application processor (AP), and so forth.

The processor 3400 may store data received through the input/output device 3100 in the memory device 3300 or control an operation of the electronic device 3000 using the data stored in the memory device 3300. The processor 3400 may generate a command for controlling the operation of the electronic device 3000 or identify whether an event related to the electronic device 3000 occurs. The processor 3400 may inform a user of information related to the data stored in the memory device 3300 through the display device 3500. The processor 3400 may supply power to an electronic circuit included in the electronic device 3000 through the power device 3600.

In an embodiment of the present disclosure, the processor 3400 may generate the depth map image based on the sensing data received from the sensing device 3200. In order to improve the depth map image generation speed, the processor 3400 may perform a sampling operation on the sensing data and generate the depth map image using intermediate data on which the sampling operation is performed. In order to improve the accuracy of the depth map image, which is lowered when the sensing data is used as is due to sampling operation performance, the processor 3400 may perform the guide filtering operation using the original image included in the sensing data as the guide image on the generated depth map image. The processor 3400 may store the sensing data in a buffer included in the memory device 3300 in order to use the sensing data after the sampling operation.

The display device 3500 may display state information of the electronic device 3000 or may display a message for an event occurrence. The power device 3600 may supply power to each of components of the electronic device 3000 or manage a battery. The power device 3600 may operate in a power saving mode for extended battery life or generate power required for each of the components of the electronic device 3000.

The scope of the present disclosure is indicated by the claims below rather than the detailed description, and all changes or modifications derived from the meaning and scope of the claims and their equivalent concepts are interpreted as being included in the scope of the present disclosure.

What is claimed is:

1. An image signal processor comprising:
a depth map generator configured to generate, based on a target resolution of an output image, a downsized left image and a downsized right image based on an input image received from an external device, and generate a depth map image indicating depth values corresponding to pixels included in the output image based on the downsized left image and the downsized right image; and
a noise remover configured to perform guide filtering on the depth map image using the input image as a guide image and generate the output image.

2. The image signal processor of claim 1, wherein the depth map generator calculates at least one disparity value between the left image and the right image based on similarity of the left image and the right image and calculates the depth values based on the at least one disparity value.

3. The image signal processor of claim 2, wherein the depth map generator determines the similarity based on a pixel value difference of a pixel included in the left image and a pixel included in the right image.

4. The image signal processor of claim 2, wherein the depth map generator determines the similarity based on a correlation between a pixel included in the left image and a pixel included in the right image.

5. The image signal processor of claim 1, wherein the noise remover sets a filtering area in the guide image corresponding to a target pixel included in the depth map image and determines a pixel value for the target pixel based on pixel values included in the filtering area.

6. The image signal processor of claim 5, wherein the noise remover sets the filtering area as an area centered on the target pixel and having a predetermined size.

7. The image signal processor of claim 6, wherein the noise remover determines the pixel value for the target pixel based on an average pixel value of the pixel values included in the filtering area.

8. The image signal processor of claim 5, wherein the noise remover sets the entire area of the guide image as the filtering area and calculates at least one weight based on a distance of the target pixel and each of pixels included in the filtering area.

9. The image signal processor of claim 8, wherein the noise remover determines the pixel value of the target pixel as a weight average value of the pixel values included in the filtering area calculated based on the at least one weight.

10. A method of operating an image signal processor, the method comprising:
receiving a left image and a right image from an external device;
determining at least one similarity value between a left pixel sampled from the left image according to a ratio determined based on target resolution of an output image and right pixels sampled from the right image according to the ratio;
calculating a disparity value between the left pixel and a comparison pixel determined based on the at least one similarity value for the right pixels;
generating, based on the disparity value, a depth map image indicating depth values corresponding to pixels included in the output image; and
performing a guide filtering operation on the depth map image using the left image as a guide image.

11. The method of claim 10, wherein determining the similarity comprises calculating the similarity based on a pixel value difference between the left pixel and the right pixel.

12. The method of claim 10, wherein determining the similarity comprises calculating based on a normalized correlation between the left pixel and the right pixel.

13. The method of claim 10, wherein calculating the disparity value comprises:
determining, as the comparison pixel, a pixel among the right pixels with a highest similarity to the left pixel; and
determining a distance between the left pixel and the comparison pixel as the disparity value.

14. The method of claim 10, wherein performing the guide filtering operation comprises:
setting a filtering area in the guide image, the filtering area corresponding to a target pixel included in the depth map image; and
determining a pixel value of the target pixel based on pixel values included in the filtering area.

15. The method of claim 14, wherein setting the filtering area comprises:
setting, as the filtering area, an area centered on the target pixel and having a predetermined size; and
wherein determining the pixel value of the target pixel comprises:
calculating at least one weight based on a distance of the target pixel to each pixel included in the filtering area; and
determining the pixel value of the target pixel as a weight average value of the pixel values included in the filtering area calculated based on the at least one weight.

16. An image system comprising:
an image sensor including a plurality of pixels and configured to generate an image including pixel values corresponding to each of the plurality of pixels; and
an image signal processor configured to perform, based on target resolution of an output image, a sampling operation on an image received from the image sensor and perform an image processing operation based on an intermediate image on which the sampling operation is performed;
wherein the image processing operation includes a noise removal operation, and
wherein the image signal processor includes a noise remover that performs a noise removal operation by guide filtering using the image received from the image sensor as a guide image.

17. The image system of claim 16, wherein the image sensor includes a plurality of phase difference pixels, wherein at least two of the plurality of phase difference pixels receive light from a same micro lens;
wherein the image processing operation is a depth map generation operation; and
wherein the image signal processor further comprises a depth map generator that generates a left image and a right image based on the intermediate image and generates a depth map image, based on the left image and right image, indicating depth values corresponding to pixels included in the output image.

18. The image system of claim 17, wherein the depth map generator calculates a disparity value for the left image and the right image based on similarity between the left image and the right image and calculates the depth values based on the disparity value.

19. The image system of claim 17, wherein the noise remover sets a filtering area in the guide image, the filtering area corresponding to a target pixel included in the depth map image and determines a pixel value of the target pixel based on pixel values included in the filtering area.

20. An image system comprising:
an image sensor including a plurality of pixels and configured to generate an input image; and
a processor and memory configured to:
generate a downsized left image and a downsized right image based on the input image;
generate a depth map image indicating depth values based on the downsized left image and the downsized right image;
remove noise by guide filtering the depth map image using the input image as a guide image; and
generate an output image based on the guide-filtered depth map image.
